(19) United States
(12) Patent Application Publication
(10) Pub. No.: US 2024/0006735 A1
(43) Pub. Date: Jan. 4, 2024

(54) STACKED TRANSCEIVER AND WAVEGUIDE LAUNCHER ARRAY

(71) Applicant: Intel Corporation, Santa Clara, CA (US)

(72) Inventors: Georgios C. DOGIAMIS, Chandler, AZ (US); Neelam PRABHU GAUNKAR, Chandler, AZ (US); Nada SEKELJIC, Hillsboro, OR (US)

(21) Appl. No.: 17/853,597

(22) Filed: Jun. 29, 2022

(51) Int. Cl. H04B 1/40; H01P 3/16; H01P 11/00

(52) U.S. Cl. CPC H04B 1/40; H01P 11/006; H01P 3/16

(57) ABSTRACT

Embodiments herein relate to systems, apparatuses, or processes for packages that include transceivers that are at least partly positioned underneath a waveguide launcher array to decrease the maximum signal transmission time between the transceiver and the waveguide launcher array. This configuration may increase the overall data transmission rate between a die and waveguides coupled with the waveguide launcher array. Other embodiments may be described and/or claimed.

### FIELD

Embodiments of the present disclosure generally relate to the field of package assemblies, and in particular package assemblies that include mmWave transceivers.

### BACKGROUND

Higher data bandwidth and increased data speed between computing components, in particular within data centers, will become increasingly important. As a result, architectures will need to adapt to increased speed and higher frequency signal transmission, while minimizing cost. These higher frequency signal transmissions may occur, for example, within high-speed interconnects in racks in a data center, between blades in a server, or between sockets.

### BRIEF DESCRIPTION OF THE DRAWINGS

FIG. 1 illustrates top-down views and a cross section side view of a package that includes a transceiver (TRX) next to a central processing unit (CPU), and a waveguide launcher array next to the TRX.

FIG. 2 illustrates a cross section side view of a substrate that includes a package with a TRX that includes digital circuitry and analog circuitry, with the analog circuitry beneath a waveguide launcher array that is coupled with dielectric-clad dielectric waveguides, in accordance with various embodiments.

FIG. 3 illustrates a cross section side view of a substrate with a TRX on a side of the substrate, and a waveguide launcher array above the TRX, in accordance with various embodiments.

FIG. 4 illustrates a top-down view of a package that has a system-on-a-chip (SOC) surrounded by 12 waveguide launcher arrays each with at least a portion of a TRX, respectively, below the waveguide launcher arrays, in accordance with various embodiments.

FIGS. 5A-5C illustrate a cross section side view and various top-down cross section views of a package with a digital die and an analog die that form a TRX beneath a waveguide launcher array that is coupled with metallic shielded dielectric waveguides, in accordance with various embodiments.

FIGS. 6A-6C illustrate cross section side views of analog circuitry beneath a waveguide launcher array that is coupled with metallic shielded dielectric waveguides, in accordance with various embodiments.

FIG. 7 illustrates an example of a process for manufacturing a stacked transceiver and waveguide launcher array, in accordance with various embodiments.

FIG. 8 schematically illustrates a computing device, in accordance with various embodiments.

### DETAILED DESCRIPTION

Embodiments of the present disclosure may generally relate to systems, apparatus, and/or processes directed to packages that include transceivers that are at least partly positioned underneath a waveguide launcher array to decrease the maximum signal transmission distance between the transceiver and the waveguide launcher array. Embodiments described herein may increase the overall data transmission rate between a die, such as a central processor unit (CPU), a graphics processor unit (GPU), or a SOC, and waveguides coupled with the waveguide launcher array. Embodiments described herein may facilitate new architectures that allow for a higher bandwidth density at a lower cost compared to optical systems, with increased design flexibility that includes modularizing TRX and waveguide launcher array packages.

In embodiments, a transceiver may include digital circuitry and analog circuitry, and may be divided into multiple dies. For example, one die may contain digital circuitry to send or receive digital signals from/to a CPU, and another die may include analog/radiofrequency (RF) circuitry that is coupled with the waveguide launcher array, which in turn is coupled with a plurality of waveguides.

In embodiments, a separate package may be created that includes the transceiver, one or more routing layers above the transceiver that includes the waveguide launcher array, and waveguide connectors coupled with the waveguide launcher array. The package may then be placed on a substrate that includes a bridge in the substrate that electrically couples the transceiver with a CPU on the substrate. In embodiments, a metallic-shielded dielectric waveguide may be coupled with the waveguide connectors.

In other embodiments, a dielectric clad dielectric waveguide, which may be referred to as a dielectric waveguide, may be coupled with the waveguide connectors. The dielectric waveguide may include a small diameter dielectric surrounded by a larger dielectric of different material. In some embodiments, a metal shielded dielectric waveguide, which may be referred to as a metallic shielded dielectric waveguide or a metallic waveguide, may have a smaller overall diameter compared to a dielectric waveguide. In embodiments the metallic shielded dielectric waveguide may be coupled with a dielectric clad dielectric waveguide using a waveguide connector.

In embodiments, the dielectric clad dielectric waveguide may extend the reach of the interconnect system by several meters. In addition, embodiments may be directed to architectures to combine analog/RF and digital, deep-scaled nodes, or integrated circuits, for optimized performance with waveguide launcher arrays. In embodiments, using dielectric clad dielectric waveguides may have a large cross-section area that may increase the package area around a main CPU. In other embodiments, decoupling the substrate that includes the CPU from a substrate that includes the transceiver and the waveguide launcher arrays will address the area increase.

Legacy servers use low-frequency, for example below mm-wave frequencies, high-speed interconnects for communication within data centers. This communication may include rack to rack, blade to blade, and/or socket to socket communication. The electrical fabrics used in these legacy implementations are limited in their ability to trade off data rate versus distance. For example, the distance reduces significantly as the data rate goes up, unless substantial equalization and complex error correction algorithms is used. In general, in these legacy implementations cost and cable cross-sectional size increase with increasing data rates and increases interconnect reaches.

As a result, embodiments may achieve a higher bandwidth density, and optimized performance, for example reduced area and increased power, by implementing a digital-intensive functions on a deep scaled node, and analog-intensive operations to an RF-optimized node. In addition, decoupling the CPU substrate from the transceiver/waveguide launcher array substrate may achieve lower costs, and decoupling the digital circuitry from the analog circuitry within the transceiver for independent operation may achieve higher link performance, lower insertion loss, and better area utilization.

In legacy implementations, to overcome such limitations and increase transmission distance, error correction schemes on traditional electrical fabrics are used. However, this may lead to substantial latency increases, which may be on the order of several hundreds of nanoseconds. For example, at 224 Gb per second generation, reach distances for transmission over legacy twinaxial electrical cables have reduced to around 1 meter or less from five meters at the 56 Gbps generation.

Other legacy implementations include optical interconnect fabrics that use silicon photonics and various semiconductor technologies along with optical fibers. These legacy implementations enable extremely high data rates over very long distances. However, for medium distance communications, for example within a server farm, the overhead power requirements associated with the optical fabric may be too high. In addition, there is a low misalignment tolerance for optical connections, and also a reduced temperature range for operation, which together lead to increased total cost of ownership. This is particularly true as the number of waveguides scale into the hundreds or thousands. As a result, the legacy implementation techniques, traditional electrical and optical, may not be optimal for server architectures where transmission ranges are between two and five meters and include several hundreds of lanes operating simultaneously.

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

Various operations may be described as multiple discrete operations in turn, in a manner that is most helpful in understanding the claimed subject matter. However, the order of description should not be construed as to imply that these operations are necessarily order dependent.

As used herein, the term “module” may refer to, be part of, or include an ASIC, an electronic circuit, a processor (shared, dedicated, or group) and/or memory (shared, dedicated, or group) that execute one or more software or firmware programs, a combinational logic circuit, and/or other suitable components that provide the described functionality.

Various Figures herein may depict one or more layers of one or more package assemblies. The layers depicted herein are depicted as examples of relative positions of the layers of the different package assemblies. The layers are depicted for the purposes of explanation, and are not drawn to scale. Therefore, comparative sizes of layers should not be assumed from the Figures, and sizes, thicknesses, or dimensions may be assumed for some embodiments only where specifically indicated or discussed.

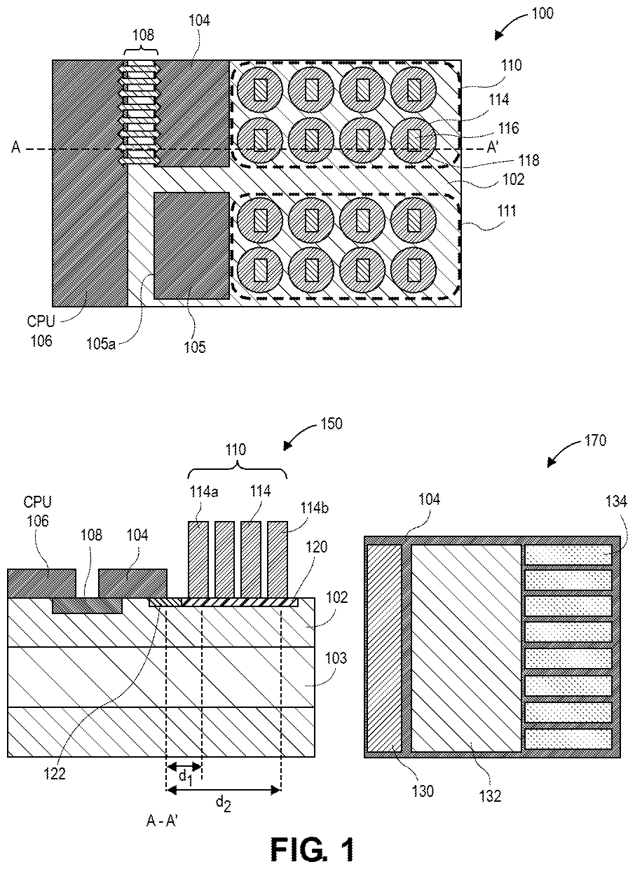

FIG. 1 illustrates top-down views and a cross section side view of a package that includes a TRX next to a CPU, and a waveguide launcher array next to the TRX. Partial legacy package 100 shows a top-down view of a substrate 102 that includes a first transceiver 104 and a second transceiver 105 on the substrate 102. The first transceiver 104 and the second transceiver 105 may be proximate to a CPU 106 that may also be on the substrate 102. The transceivers 104, 105 may be electrically coupled with the CPU 106 through a bridge 108 that may be embedded within the substrate 102. In other implementations, some other high density interface may be used in place of the bridge 108.

A length of an edge 105a of transceiver 105 may be referred to as a shoreline width, and may range from 5 mm to 20 mm. As shown, the shoreline length is 10 mm. In implementations, a size of the transceivers 104, 105 may range from 10×5 mm to 10×10 mm. In other implementations, the size may be larger.

In implementations, a first group of waveguides 110 may be coupled with the first transceiver 104, and a second group of waveguides 111 maybe coupled with the second transceiver 105. An individual waveguide 114, which is a dielectric clad dielectric waveguide, may include an inner dielectric layer 116 that is surrounded by an outer dielectric layer 118. In implementations, the inner dielectric layer 116 may have a thin core, for example 1 mm, and may be surrounded by the outer dielectric layer 118 that may have an outer dimension of 1500 to 3000 μm, which serves as a cladding around the inner dielectric layer 116. Note that the inner dielectric layer 116 is shown as a rectangle, however it may have any cross-section shape. In other embodiments a bundle of waveguide of any cross-section shape may be embedded under a common cladding material.

Note that the overall diameter of the dielectric clad dielectric waveguide may be less than 10 mm, however this may vary based upon frequencies of operation and the dielectric material properties. For example at 140 GHz the diameter of the waveguide 114 may range from 1.5 mm to 6 mm when employing a dielectric with a low-dielectric constant (Dk), for example a Dk on the order of 2. In another example at 140 GHz, the diameter of the waveguide 114 may range from 0.5 to 3 mm when employing high-dielectric constant materials, for example with a Dk˜10. In higher frequency of operations, for example 280 GHz, waveguide 114 may range from 0.4 mm to 3 mm. In implementations, a width of the transceiver 104 may be on the order of 10 mm. In implementations (not shown), transceivers 104, 105 may support up to eight lanes, for example 8 receive waveguides and 8 transmit waveguides, for a total of 16 waveguides, which may make up one waveguide bundle.

Partial legacy package 150 is a cross section side view of partial legacy package 100 at A-A′. Bridge 108 is recessed into the substrate 102, and electrically couples the CPU 106 with the transceiver 104. The transceiver 104 is then electrically coupled with the waveguide launcher array 120, which is also at or near the surface of the substrate 102, using traces 122. Multiple waveguides 114 may then couple with the waveguide launcher array 120, to send and receive signals along the multiple waveguides 114. The waveguide launcher array 120 may be electromagnetic launchers, which may be of a stacked-pitch type, patch, monopole, dipole, Vivaldi-like, tapered-slot launchers, multimode launchers, and dual polarization launchers, and the like. A connector mechanism (not shown) is used to interface the first group of waveguides 110 to the waveguide launcher array 120, and has been omitted for clarity. The connector mechanism may be made out of metallic, conductive plastic or semi-insulative plastic materials to facilitate a robust interface between the waveguide launcher array 120 and a waveguide bundle of waveguides 110.

Note that because the transceiver 104 is at a side of the first group of waveguides 110, a distance d₁ between the transceiver 104 and a first waveguide 114a may be significantly shorter than a distance d₂ between the transceiver 104 and a second waveguide 114b. In particular, if the diameter of the waveguide 114 is approximately 4 mm, then the distance of a signal traveling from the transceiver 104 to the second waveguide 114b may travel an additional 12 to 16 mm as compared to the signal traveling from the transceiver 104 to the first waveguide 114a. In implementations (not shown) where a total of eight waveguides 114 may be in a line, the difference in length of signal travel may be on the order of 30 to 32 mm. As a result, there may be a significant insertion loss experienced by the signal traveling between the transceiver 104 and waveguides 114b. Moreover, there may be a significant time delay in the signal traveling between the transceiver 104 and the second waveguide 114b, as compared to the time it takes the signal to travel between the transceiver 104 and the first waveguide 114a which may increase the complexity of the digital correction and equalization of the link

Diagram 170 shows a detailed diagram of transceiver 104, that includes an area for input/output (I/O) 130. It also includes an area 132 for digital signal processing (DSP), analog digital conversion (ADC), and equalizer (EQ) functions that is coupled with individual Tx/Rx channels 134, which may electrically couple with traces 122, to in turn electrically couple with the waveguide launcher array 120. In some embodiments the area 132 may include a multi-input multi-output equalizer.

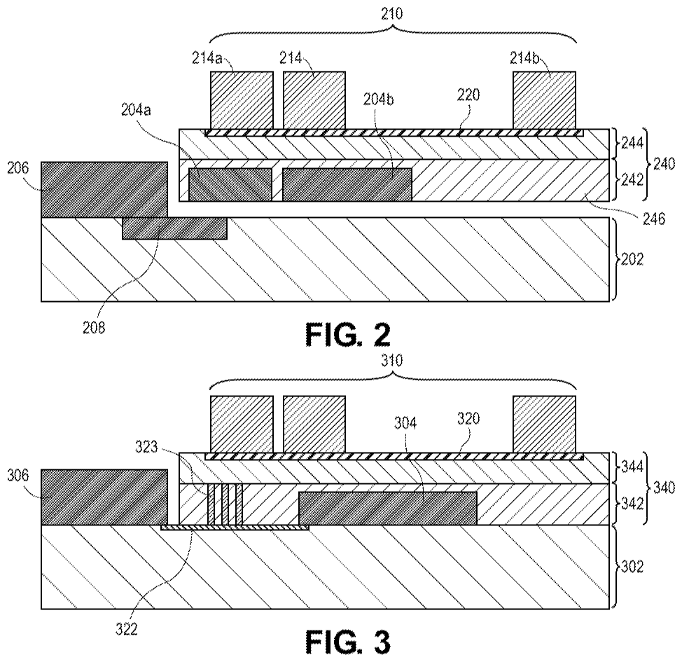

FIG. 2 illustrates a cross section side view of a substrate that includes a package with a TRX that includes digital circuitry and analog circuitry, with the analog circuitry beneath a waveguide launcher array that is coupled with dielectric-clad dielectric waveguides, in accordance with various embodiments. Package 240 includes a front side layer 244 that is on top of a TRX layer 242. The TRX layer 242 may include digital circuitry 204a, which may also be referred to as a digital node, a scaled digital node, or an I/O portion of a TRX. The TRX layer 242 may also include analog/RF circuitry 204b, which may also be referred to as sub-THz, mmWave, or Rx/Tx circuitry, or may be referred to as an RF-optimized node. In embodiments, the digital circuitry 204a and the analog/RF circuitry 204b together may provide functionality that is similar to functionality provided by transceiver (TRX) 104 of FIG. 1.

In embodiments, TRX functionalities are split into a digital circuitry 204a die and an analog/RF circuitry 204b die in order to optimize the performance of the respective subsystems by using a dedicated process for each. In embodiments, the digital circuitry 204a may be developed on a scaled digital node, for example using 7 nm, 5 nm, 4 nm, 3 nm, or 2 nm process implementations. The analog/RF circuitry 204b die may be developed on an RF-optimized node, for example using RF-silicon on insulator (SOI), RF-CMOS, SiGe, BiCMOS, or other similar process technologies, to achieve increased RF performance and power advantages.

In embodiments, the digital circuitry 204a and the analog/RF circuitry 204b may each be embedded into an oxide material 246, such as SiO₂ or some other similar oxide material within a TRX layer 242. In embodiments, other silicon or dummy dies (not shown) may also be embedded into the oxide material 246 to provide quasi-monolithic stitching. In embodiments, the TRX layer 242 may be a ceramic or a glass interposer that includes cavities into which the dies that include the digital circuitry 204a and the analog/RF circuitry 204b may be embedded.

The front side layers 244 may be created using back-end-of-line (BEOL) processes that may have thick inter-layer dielectrics (not shown but discussed further below), for example 1 to 5 μm, and thick copper metallization (not shown but discussed further below), for example 1 to 5 μm that may be deposited. In embodiments, the front side layers 244 may include organic redistribution layers (RDL) (not shown but discussed further below) at a thickness which may reach several tens of micrometers. As a result, a waveguide launcher array 220, which may be similar to waveguide launcher array 120 of FIG. 1, may be built within the front side layers 244 and electrically coupled with the analog/RF circuitry 204b. In embodiments by using thicker layers, higher bandwidths within the waveguide launcher array 220 may be achieved. For example in the case of stacked-patch electromagnetic launchers, thicker dielectric layers allow for more efficient transmission and lower parasitic capacitances, which in turn allow wider bandwidths and higher performance.

The package 240 may be placed on a substrate 202, which may be similar to substrate 102 of FIG. 1. In embodiments, the package 240 may be coupled with substrate 202 using ball grid array, thermo-compression bonding, solder-based interconnect or hybrid bonding techniques. The substrate 202 may include a CPU 206 that is coupled to a bridge 208, which may be similar to CPU 106 and bridge 108 of FIG. 1, to which the digital circuitry 204a may be electrically coupled. In embodiments, the substrate 202 may include a core (not shown) that may include a glass core or a copper clad laminate (CCL) core. In embodiments, the substrate 202 may be a silicon interposer.

In embodiments, the digital circuitry 204a may communicate with the analog/RF circuitry 204b through routings (not shown) in the front side layers 244, or through routings (not shown) proximate to a surface of the substrate 202. In embodiments, the analog/RF circuitry 204b may be implemented as a die that may face upwards in order to have the shortest interconnect distance to the waveguide launcher array 220 in order to minimize routing loss. In embodiments, the digital circuitry 204a may be implemented as a die that may face either up or down. Power may be routed to the digital circuitry 204a or to the analog/RF circuitry 204b, either through the substrate 202 or through the front side layers 244.

Note that in embodiments, if both the digital circuitry 204a and the analog/RF circuitry 204b are placed in a same orientation, for example both facing upwards, then either the front side layers or the backside layers of the dies may be specially designed to ensure low loss, wideband connections and routing. For example thru-silicon vias (TSVs) may be optimized for transmission of power or RF signals.

Note also that the position of the analog/RF circuitry 204b may be configured to be underneath the group of waveguides 210 that include individual waveguides 214, which may be similar to the first group of waveguides 110 and waveguides 114 of FIG. 1. The group of waveguides 210 may be coupled with the waveguide launcher array 220. This configuration, unlike the configuration of TRX 104 to the waveguide group 110 of FIG. 1, minimizes the furthest distance between a first waveguide 214a and a second waveguide 214b that may be on opposite edges of the group of waveguides 210. In some embodiments, the configuration further reduces the complexity of the signal transition from the TRX 204 to the waveguide group 210 compared to the signal transition from the TRX 104 to the waveguide group 110 of FIG. 1.

FIG. 3 illustrates a cross section side view of a substrate with a TRX on a side of the substrate, and a waveguide launcher array above the TRX, in accordance with various embodiments. Package 340, which may be similar to package 240 of FIG. 2, includes front side layers 344 and TRX layer 342, which may be similar to front side layers 244 and TRX layer 242 of FIG. 2. A waveguide launcher array 320, which may be similar to waveguide launcher array 220 of FIG. 2, may electrically couple with TRX 304 in TRX layer 342, and may also couple with a group of waveguides 310, which may be similar to the group of waveguides 210 of FIG. 2.

In embodiments, the TRX 304 may contain both digital circuitry and analog/RF circuitry. The TRX 304 may be electrically coupled with the CPU 306, which may be similar to CPU 206 of FIG. 2 that is on the substrate 302. The CPU 306 may electrically couple with the TRX 304 using routings 322, which may be similar routings 122 of FIG. 1. In embodiments, power may be routed from the substrate 302 through dielectric vias 323 in the TRX layer 342 to the front side layers 344, which may then be routed down to the TRX 304. In other embodiments, the TRX 304 may receive power directly from the substrate 302 thru the use of TSVs. In some embodiments TRX 304 may be facing downwards and have a direct power connection to the package substrate 302 through a solder interconnect, hybrid bonding or any other interconnect system known in the art. In such embodiments the TRX 304 thickness may be sustainably reduced, for example by 20 μm to 50 μm, to allow a short low-loss wideband connection of the signal from TRX 304 to the waveguide launcher array 320.

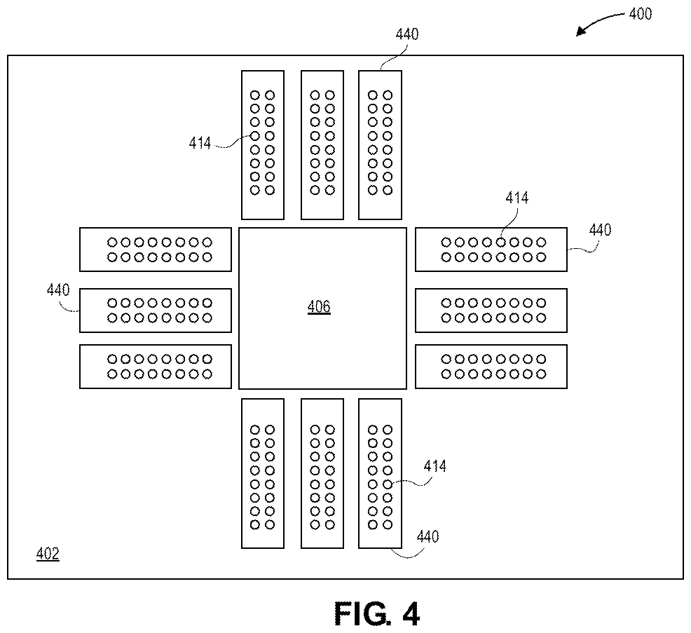

FIG. 4 illustrates a top-down view of a package that has a SOC surrounded by 12 waveguide launcher arrays each with at least a portion of a TRX, respectively, below the waveguide launcher arrays, in accordance with various embodiments. Diagram 400 shows a top-down view of a SOC 406, which may be similar to CPU 306 of FIG. 3 that is on a substrate 402, which may be similar to substrate 302 of FIG. 2.

As shown, the SOC 406 may be surrounded on all sides by a TRX packages 440, which may be similar to TRX package 340 of FIG. 3. Waveguides 414, which may be similar to waveguides 214 of FIG. 2, maybe coupled with the TRX packages 440. In embodiments, bridges (not shown) which may be similar to bridge 208 of FIG. 2, may be used to couple the SOC 406 with each TRX package 440.

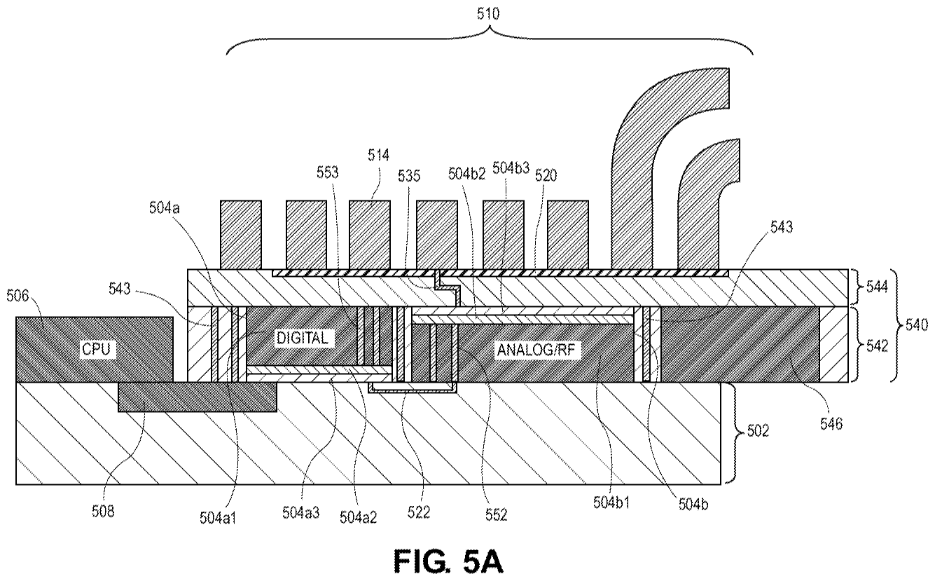

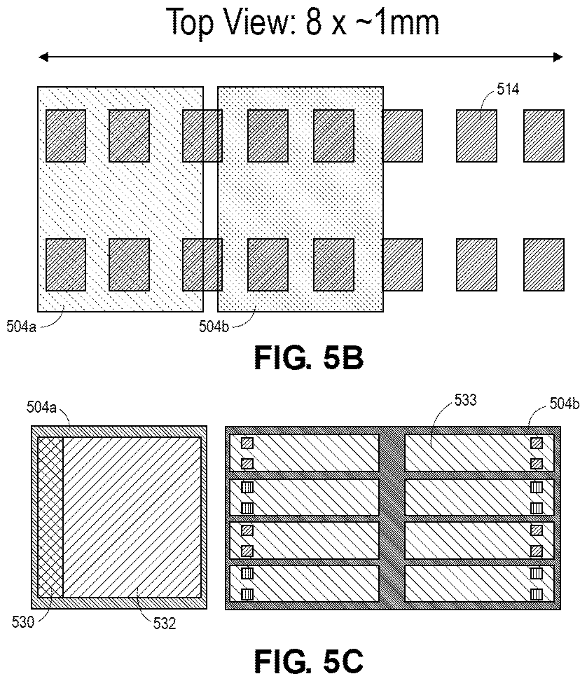

FIGS. 5A-5C illustrate a cross section side view and various top-down cross section views of a package with a digital die and an analog die that form a TRX beneath a waveguide launcher array that is coupled with metallic shielded dielectric waveguides, in accordance with various embodiments. FIG. 5A shows a cross section side view of a package 540, which may be similar to package 340 of FIG. 3, that includes front side layers 544 that include a waveguide launcher array 520, which may be similar to front side layers 344 and waveguide launcher array 320 of FIG. 3. Below the front side layers 544 there is a TRX layer 542, which may be similar to TRX layer 342 of FIG. 3.

The TRX layer 542 may include a digital circuitry die 504a and an analog/RF die 504b, which may be similar to digital circuitry 204a and analog/RF circuitry 204b of FIG. 2. The digital circuitry die 504a and the analog/RF circuitry 504b may be within a dielectric material 546, which may be similar to oxide material 246 of FIG. 2. In embodiments, the digital circuitry die 504a and the analog/RF circuitry die 504b may be within a ceramic or a glass core.

The digital circuitry die 504a may include the main substrate of the die 504a1, a front-end-of-line (FEOL) portion 504a2, and a BEOL portion 504a3. In embodiments, the BEOL 504a3 may electrically couple with a bridge 508 that is within the substrate 502, which may be similar to bridge 208 and substrate 202 of FIG. 2. In embodiments, the bridge 508 may provide a high-bandwidth density electrical coupling with a CPU 506, which may be similar to CPU 206 of FIG. 2.

Similarly, the analog/RF circuitry die 504b may include the main substrate of the die 504b1, a FEOL portion 504b2, and a BEOL portion 504b3. In embodiments, the BEOL 504b3 may be at the top of the analog/RF circuitry die 504b and electrically couple with the waveguide launcher array 520, to provide a shorter electrical path to the waveguide launcher array 520. In embodiments, the analog/RF circuitry die 504b may electrically couple with the digital circuitry die 504a using electrical routings 522, which may be similar to electrical routings 122 of FIG. 1, to route signals or power.

In embodiments, power and/or signals may be routed using through silicon vias (TSV) 552 to electrically couple the substrate 502 with the analog/RF circuitry die 504b. In embodiments, power and/or signals may be routed through TSV 553 to electrically couple the front side layers 544 with the digital circuitry die 504a. In other embodiments, through dielectric vias (TDV) 543 may route power or signals between the substrate 502 and the front side layers 544.

In embodiments, the waveguide launcher array 520 may couple into a metallic based connector, and the group of waveguides 510, which may be similar to the group of waveguides 210 of FIG. 2. In embodiments, a particular waveguide 514 may be a metallic shielded dielectric waveguide that includes a dielectric that is surrounded by a metallic shielding. In these embodiments, the waveguide 514 may be significantly thinner as compared to the dielectric clad dielectric waveguide 214 of FIG. 2. As a result, the group of waveguides 510 may be arranged in a far denser pattern as compared to the group of waveguides 210 of FIG. 2. Such denser configuration further reduces the interconnect distance between the analog/RF circuitry die 504b with the waveguide launcher array 520.

For example, at 110 GHz to 170 GHz, the area occupied by the group of waveguides 510 on a surface of the waveguide launcher array 520 may be approximately 1.7×0.85 mm, which is significantly less than the area of the group of waveguides 210 of FIG. 2, which is on the order of (pi*(2 mm)²) assuming a circular waveguide cross-section of 2 mm radius. As a result, the embodiment that involves metallic waveguides may take up a significantly smaller area, thus a greater number of packages 540 may surround the CPU 506 than the number of packages 240 that include dielectric clad dielectric waveguides 214 of FIG. 2.

In embodiments, the group of waveguides 510 may include one or more metallic waveguide connectors (not shown) which may be used to change the physical direction of the various waveguides 514. In embodiments, a coupler (not shown) may attach to the end of one or more waveguides 514 to be used to convert from a metallic shielded dielectric waveguide 514 to a dielectric clad dielectric waveguide (not shown), which may be similar to waveguide 214 of FIG. 2. In this way, thinner metallic shielded dielectric waveguides 514 that may have a higher transmission loss but allow a denser cluster for a group of waveguides 510 at package 540, may transition to a group of thicker dielectric clad dielectric waveguides that allow for lower transmission loss to their end destination. For example, above 200 GHz, signal loss due to the existence of metal shielding in a dielectric waveguide may be high (>15 dB per meter propagation loss of waveguide), where this loss does not exist in dielectric clad dielectric waveguides (e.g. <10 dB per meter propagation loss of waveguide).

FIG. 5B shows a top-down view that includes a top-down view of a plurality of metallic shielded dielectric waveguides 514 that are above digital circuitry die 504a and above analog/RF circuitry die 504b.

FIG. 5C shows a top-down view of a diagram of digital circuitry die 504a, that includes an I/O section 530 that may directly couple with a bridge 508 of FIG. 5A, and a DSP/ADC section 532 that may electrically couple with the analog/RF circuitry die 504b, either through routings on the substrate 502 or within routings on the front side layers 544 of FIG. 5A. FIG. 5C also shows a top-down view of a diagram of analog/RF circuitry die 504b that includes a plurality of analog front end 533 sections, each of which that may electrically couple with the waveguide launcher 520 of FIG. 5A using routing 535. In embodiments, the area due to the use of metallic shielded dielectric may be reduced with respect to the area used by dielectric clad dielectric waveguides, which may have a diameter on the order of 4 mm.

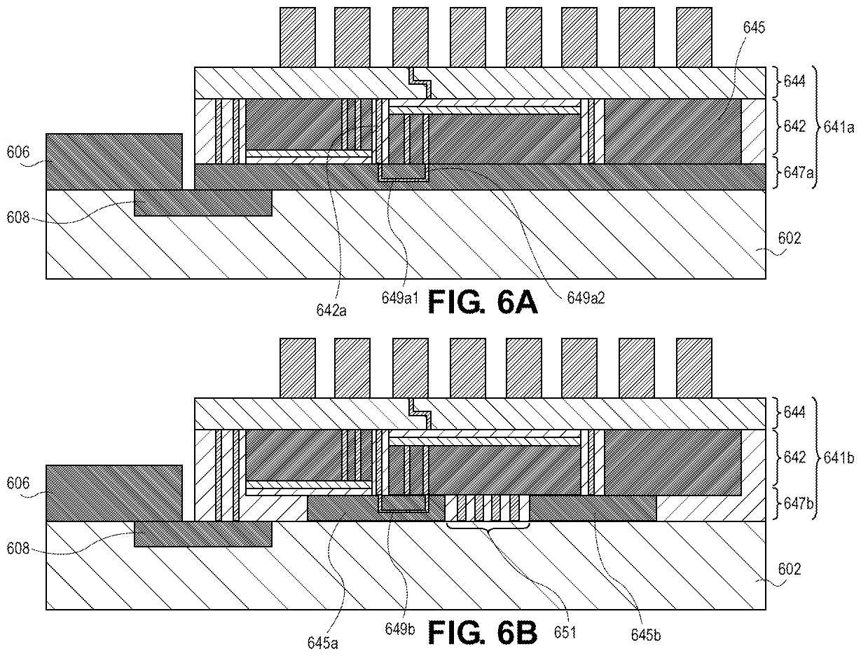

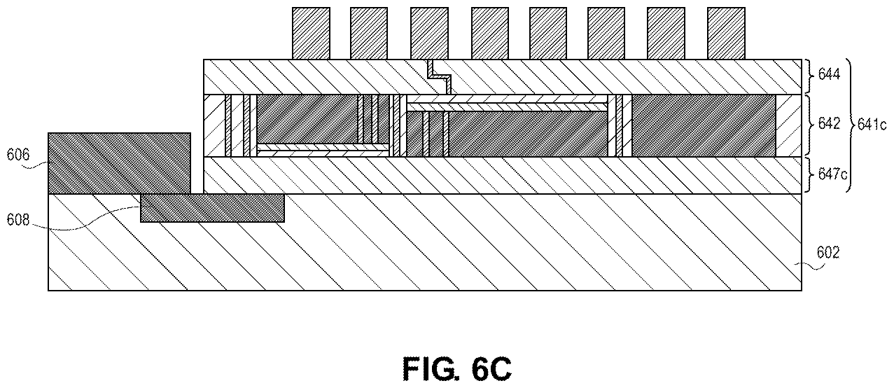

FIGS. 6A-6C illustrate cross section side views of analog circuitry beneath a waveguide launcher array that is coupled with metallic shielded dielectric waveguides, in accordance with various embodiments. FIG. 6A, which may be similar to FIG. 5A, shows a cross section side view of a package 641a, which may be similar to package 540 of FIG. 5A, that includes a front side layer 644 that is on a TRX layer 642, which may be similar to front side layer 544 and TRX layer 542 of FIG. 5A.

In this embodiment, an interposer layer 647a may be between the TRX layer 642 and the substrate 602, which may include routings 649a1 and vias 649a2 to facilitate electrical routing between the components in the TRX layer 642, the substrate 602, and the bridge 608, which may be similar to bridge 508 of FIG. 5A. In embodiments, one or more dummy dies 645 may be within the TRX layer 642 to provide a quasi-monolithic TRX layer 642 and enable better mechanical properties of the 641a module. In embodiments, the bridge 608 may be electrically coupled with the CPU 606, which may be similar to CPU 506 of FIG. 5A.

In embodiments, the interposer layer 647a may include through silicon vias (TSV) (not shown) to pass power and/or I/O signals between the substrates 602 and any dies or die complexes within the package 641a. In embodiments, routing 649a1 may also connect between various dies within the package 641a using a through dielectric via (TDV) 642a. In embodiments, the interposer layer 647a may have active structures (not shown), which may include memory, or other digital functions.

FIG. 6B, which may be similar to FIG. 6A, shows a cross section side view of a package 641b, which may be similar to package 641a of FIG. 6A, that includes a front side layer 644 on top of a TRX layer 642, as also shown in FIG. 6A. Layer 647b shows two interposer layers 645a, 645b that are split apart, with vias 651 bringing power into the TRX layer 642 from the substrate 602 between the two interposer layers 645a, 645b. In embodiments, the interposer layer 645a may contain various electrical routings 659b that facilitate electrical routing between the components in the TRX layer 642, the substrate 602, and the bridge 608.

FIG. 6C, which may be similar to FIG. 6A, shows a cross section side view of a package 641c, which may be similar to package 641a of FIG. 6A, that includes a front side layer 644 on top of a TRX layer 642, as also shown in FIG. 6A. Layer 647c is a backside layer, that may be similar to front side layer 644, that may include routings (not shown) to electrically couple elements within the TRX layer 642, within the substrate 602 including the bridge 608, and to electrically couple with the CPU 606.

With respect to the embodiments discussed with respect to FIGS. 6A-6C, various routings of signals through vias, which may be challenging due to increased parasitics and substrate loss, may instead use specially designed vias, for example a coaxial type via, to facilitate lower loss.

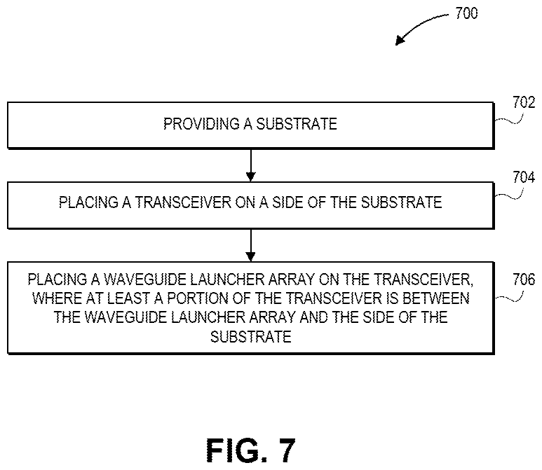

FIG. 7 illustrates an example of a process for manufacturing a stacked transceiver and waveguide launcher array, in accordance with various embodiments. In embodiments, process 700 may be performed using apparatus, systems, processes, and/or techniques described herein, and in particular with respect to FIGS. 1-6C.

At block 702, the process may include providing a substrate. In embodiments, the substrate may be similar to substrate 202 of FIG. 2, substrate 302 of FIG. 3, substrate 402 of FIG. 4, substrate 502 of FIGS. 5A-5C, or substrate 602 of FIGS. 6A-6C. In embodiments, the substrate may include a bridge, which may be similar to bridge 208 of FIG. 2, bridge 308 of FIG. 3, bridge 408 of FIG. 4, bridge 508 of FIG. 5A, or bridge 608 of FIGS. 6A-6C.

At block 704, the process may further include placing a transceiver on a side of the substrate. In embodiments, the transceiver may be similar to transceiver 104 of FIG. 1, digital circuitry 204a and analog/RF circuitry 204b of FIG. 2, TRX 304 of FIG. 3, or digital circuitry die 504a and analog/RF circuitry die 504b of FIG. 5A.

At block 706, the process may further include placing a waveguide launcher array on the transceiver, where at least a portion of the transceiver is between the waveguide launcher array and the side of the substrate. In embodiments, the waveguide launcher array may be similar to waveguide launcher array 220 of FIG. 2, waveguide launcher array 320 of FIG. 3, or waveguide launcher array 520 of FIG. 5A.

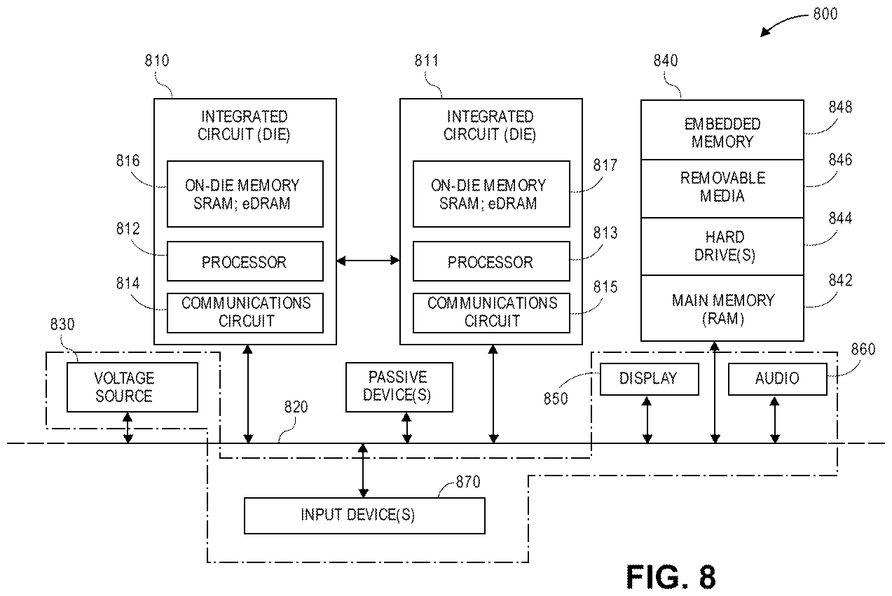

FIG. 8 is a schematic of a computer system 800, in accordance with an embodiment of the present invention. The computer system 800 (also referred to as the electronic system 800) as depicted can embody a stacked transceiver and waveguide launcher array, according to any of the several disclosed embodiments and their equivalents as set forth in this disclosure. The computer system 800 may be a mobile device such as a netbook computer. The computer system 800 may be a mobile device such as a wireless smart phone. The computer system 800 may be a desktop computer. The computer system 800 may be a hand-held reader. The computer system 800 may be a server system. The computer system 800 may be a supercomputer or high-performance computing system.

In an embodiment, the electronic system 800 is a computer system that includes a system bus 820 to electrically couple the various components of the electronic system 800. The system bus 820 is a single bus or any combination of busses according to various embodiments. The electronic system 800 includes a voltage source 830 that provides power to the integrated circuit 810. In some embodiments, the voltage source 830 supplies current to the integrated circuit 810 through the system bus 820.

The integrated circuit 810 is electrically coupled to the system bus 820 and includes any circuit, or combination of circuits according to an embodiment. In an embodiment, the integrated circuit 810 includes a processor 812 that can be of any type. As used herein, the processor 812 may mean any type of circuit such as, but not limited to, a microprocessor, a microcontroller, a graphics processor, a digital signal processor, or another processor. In an embodiment, the processor 812 includes, or is coupled with, a stacked transceiver and waveguide launcher array, as disclosed herein. In an embodiment, SRAM embodiments are found in memory caches of the processor. Other types of circuits that can be included in the integrated circuit 810 are a custom circuit or an application-specific integrated circuit (ASIC), such as a communications circuit 814 for use in wireless devices such as cellular telephones, smart phones, pagers, portable computers, two-way radios, and similar electronic systems, or a communications circuit for servers. In an embodiment, the integrated circuit 810 includes on-die memory 816 such as static random-access memory (SRAM). In an embodiment, the integrated circuit 810 includes embedded on-die memory 816 such as embedded dynamic random-access memory (eDRAM).

In an embodiment, the integrated circuit 810 is complemented with a subsequent integrated circuit 811. Useful embodiments include a dual processor 813 and a dual communications circuit 815 and dual on-die memory 817 such as SRAM. In an embodiment, the dual integrated circuit 810 includes embedded on-die memory 817 such as eDRAM.

In an embodiment, the electronic system 800 also includes an external memory 840 that in turn may include one or more memory elements suitable to the particular application, such as a main memory 842 in the form of RAM, one or more hard drives 844, and/or one or more drives that handle removable media 846, such as diskettes, compact disks (CDs), digital variable disks (DVDs), flash memory drives, and other removable media known in the art. The external memory 840 may also be embedded memory 848 such as the first die in a die stack, according to an embodiment.

In an embodiment, the electronic system 800 also includes a display device 850, an audio output 860. In an embodiment, the electronic system 800 includes an input device such as a controller 870 that may be a keyboard, mouse, trackball, game controller, microphone, voice-recognition device, or any other input device that inputs information into the electronic system 800. In an embodiment, an input device 870 is a camera. In an embodiment, an input device 870 is a digital sound recorder. In an embodiment, an input device 870 is a camera and a digital sound recorder.

As shown herein, the integrated circuit 810 can be implemented in a number of different embodiments, including a package substrate having a stacked transceiver and waveguide launcher array, according to any of the several disclosed embodiments and their equivalents, an electronic system, a computer system, one or more methods of fabricating an integrated circuit, and one or more methods of fabricating an electronic assembly that includes a package substrate having a stacked transceiver and waveguide launcher array, according to any of the several disclosed embodiments as set forth herein in the various embodiments and their art-recognized equivalents. The elements, materials, geometries, dimensions, and sequence of operations can all be varied to suit particular I/O coupling requirements including array contact count, array contact configuration for a microelectronic die embedded in a processor mounting substrate according to any of the several disclosed package substrates having a stacked transceiver and waveguide launcher array embodiments and their equivalents. A foundation substrate may be included, as represented by the dashed line of FIG. 8. Passive devices may also be included, as is also depicted in FIG. 8.

### Examples

The following paragraphs describe examples of various embodiments.

Example 1 is a package comprising: a waveguide launcher array; transceiver circuitry electrically coupled with the waveguide launcher array; and wherein the waveguide launcher array and at least a portion of the transceiver circuitry are in a stack formation with respect to a plane of the waveguide launcher array.

Example 2 includes the package of example 1, or of any other example or embodiment herein, wherein the transceiver circuitry includes digital circuitry and analog circuitry.

Example 3 includes the package of example 2, or of any other example or embodiment herein, wherein the waveguide launcher array and at least a portion of the analog circuitry are in the stack formation.

Example 4 includes the package of example 2, or of any other example or embodiment herein, wherein the digital circuitry is in a first die and the analog circuitry is in a second die that is separate and distinct from the first die.

Example 5 includes the package of example 4, or of any other example or embodiment herein, wherein the second die is electrically coupled with the waveguide launcher array through backside metal layers of the second die.

Example 6 includes the package of example 4, or of any other example or embodiment herein, wherein a backside metal layer of the first die is facing in a first direction away from the waveguide launcher array, and wherein a backside metal layer of the second die is facing in a second direction toward the waveguide launcher array.

Example 7 includes the package of example 4, or of any other example or embodiment herein, wherein the first die is implemented in a scaled digital node, and wherein the second die is an RF-optimized node.

Example 8 includes the package of example 4, or of any other example or embodiment herein, wherein the first die and the second die are embedded in a selected one of: a ceramic interposer or a glass interposer.

Example 9 includes the package of example 1, or of any other example or embodiment herein, wherein the waveguide launcher array is in a layer that includes electrical routings; and wherein the layer is physically coupled with the transceiver circuitry.

Example 10 includes the package of example 9, or of any other example or embodiment herein, wherein the electrical routings in the layer provide power to the transceiver circuitry.

Example 11 includes the package of example 1, or of any other example or embodiment herein, further comprising a connector for a plurality of waveguides coupled with the waveguide launcher array.

Example 12 includes the package of example 11, or of any other example or embodiment herein, wherein a first subset of the plurality of waveguides are transmit waveguides, and a second plurality of the waveguides are receive waveguides.

Example 13 includes the package of example 11, or of any other example or embodiment herein, wherein the connector for the plurality of waveguides further includes a connector for a selected one or more of: a dielectric clad dielectric waveguide or a metallic shielded dielectric waveguide.

Example 14 includes the package of example 13, or of any other example or embodiment herein, further comprising: the metallic shielded dielectric waveguide that has a first end at the connector, and a second end opposite the first end; and a dielectric clad dielectric waveguide converter at the second and of the metallic shielded dielectric waveguide, wherein the dielectric clad dielectric waveguide converter couples the metallic shielded dielectric waveguide with a dielectric clad dielectric.

Example 15 includes the package of example 14, or of any other example or embodiment herein, wherein the package is coupled with a substrate, wherein the substrate further includes a die on the substrate, the die electrically coupled with the transceiver circuitry.

Example 16 includes the package of example 15, or of any other example or embodiment herein, wherein the die is electrically coupled with the transceiver circuitry using a selected one or more of: a bridge, an interconnect, conductive traces, or a routing layer proximate to a side of the substrate.

Example 17 is a system comprising: a substrate; a system on chip (SOC) on a side of the substrate; a transceiver die complex on the side of the substrate, wherein the transceiver die complex is electrically coupled to the SOC; and a waveguide launcher array on the transceiver die complex, wherein at least a portion of the transceiver die complex is between the waveguide launcher array and the side of the substrate in a direction perpendicular to the side of the substrate.

Example 18 includes the system of example 17, or of any other example or embodiment herein, wherein the transceiver die complex includes digital die and an analog die, and wherein at least a portion of the analog die is between the waveguide launcher and the side of the substrate.

Example 19 includes the system of example 17, or of any other example or embodiment herein, wherein the SOC is electrically coupled with the transceiver die complex using a selected one or more of: a bridge, an interposer, an interconnect, or a routing layer proximate to the side of the substrate.

Example 20 includes the system of example 17, or of any other example or embodiment herein, wherein the SOC includes a selected one or more of: a CPU, an XPU, or a graphics processor.

Example 21 includes the system of example 17, or of any other example or embodiment herein, wherein the transceiver die complex includes a plurality of transceiver die complexes, and wherein the waveguide launcher array includes a plurality of waveguide launcher arrays.

Example 22 includes the system of example 21, or of any other example or embodiment herein, wherein the plurality of transceiver die complexes are electrically coupled with the SOC along two or more edges of the SOC.

Example 23 is a method comprising: providing a substrate; placing a transceiver on a side of the substrate; and placing a waveguide launcher array on the transceiver, wherein at least a portion of the transceiver is between the waveguide launcher array and the side of the substrate.

Example 24 includes the method of example 23, or of any other example or embodiment herein, wherein the transceiver includes digital circuitry and analog circuitry, and wherein at least a portion of the analog circuitry is between the waveguide launcher array and the side of the substrate.

Example 25 includes the method of example 23, or of any other example or embodiment herein, further comprising: placing a die on the side of the substrate; and electrically coupling the die to the transceiver.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated embodiments, including what is described in the Abstract, is not intended to be exhaustive or to limit embodiments to the precise forms disclosed. While specific embodiments are described herein for illustrative purposes, various equivalent modifications are possible within the scope of the embodiments, as those skilled in the relevant art will recognize.

These modifications may be made to the embodiments in light of the above detailed description. The terms used in the following claims should not be construed to limit the embodiments to the specific implementations disclosed in the specification and the claims. Rather, the scope of the invention is to be determined entirely by the following claims, which are to be construed in accordance with established doctrines of claim interpretation.

What is claimed is:

1. A package comprising:
a waveguide launcher array;
transceiver circuitry electrically coupled with the waveguide launcher array; and
wherein the waveguide launcher array and at least a portion of the transceiver circuitry are in a stack formation with respect to a plane of the waveguide launcher array.

2. The package of claim 1, wherein the transceiver circuitry includes digital circuitry and analog circuitry.

3. The package of claim 2, wherein the waveguide launcher array and at least a portion of the analog circuitry are in the stack formation.

4. The package of claim 2, wherein the digital circuitry is in a first die and the analog circuitry is in a second die that is separate and distinct from the first die.

5. The package of claim 4, wherein the second die is electrically coupled with the waveguide launcher array through backside metal layers of the second die.

6. The package of claim 4, wherein a backside metal layer of the first die is facing in a first direction away from the waveguide launcher array, and wherein a backside metal layer of the second die is facing in a second direction toward the waveguide launcher array.

7. The package of claim 4, wherein the first die is implemented in a scaled digital node, and wherein the second die is an RF-optimized node.

8. The package of claim 4, wherein the first die and the second die are embedded in a selected one of: a ceramic interposer or a glass interposer.

9. The package of claim 1, wherein the waveguide launcher array is in a layer that includes electrical routings; and wherein the layer is physically coupled with the transceiver circuitry.

10. The package of claim 9, wherein the electrical routings in the layer provide power to the transceiver circuitry.

11. The package of claim 1, further comprising a connector for a plurality of waveguides coupled with the waveguide launcher array.

12. The package of claim 11, wherein a first subset of the plurality of waveguides are transmit waveguides, and a second plurality of the waveguides are receive waveguides.

13. The package of claim 11, wherein the connector for the plurality of waveguides further includes a connector for a selected one or more of: a dielectric clad dielectric waveguide or a metallic shielded dielectric waveguide.

14. The package of claim 13, further comprising:
the metallic shielded dielectric waveguide that has a first end at the connector, and a second end opposite the first end; and
a dielectric clad dielectric waveguide converter at the second and of the metallic shielded dielectric waveguide, wherein the dielectric clad dielectric waveguide converter couples the metallic shielded dielectric waveguide with a dielectric clad dielectric.

15. The package of claim 1, wherein the package is coupled with a substrate, wherein the substrate further includes a die on the substrate, the die electrically coupled with the transceiver circuitry.

16. The package of claim 15, wherein the die is electrically coupled with the transceiver circuitry using a selected one or more of: a bridge, an interconnect, conductive traces, or a routing layer proximate to a side of the substrate.

17. A system comprising:
a substrate;
a system on chip (SOC) on a side of the substrate;
a transceiver die complex on the side of the substrate, wherein the transceiver die complex is electrically coupled to the SOC; and
a waveguide launcher array on the transceiver die complex, wherein at least a portion of the transceiver die complex is between the waveguide launcher array and the side of the substrate in a direction perpendicular to the side of the substrate.

18. The system of claim 17, wherein the transceiver die complex includes digital die and an analog die, and wherein at least a portion of the analog die is between the waveguide launcher and the side of the substrate.

19. The system of claim 17, wherein the SOC is electrically coupled with the transceiver die complex using a selected one or more of: a bridge, an interposer, an interconnect, or a routing layer proximate to the side of the substrate.

20. The system of claim 17, wherein the SOC includes a selected one or more of: a CPU, an XPU, or a graphics processor.

21. The system of claim 17, wherein the transceiver die complex includes a plurality of transceiver die complexes, and wherein the waveguide launcher array includes a plurality of waveguide launcher arrays.

22. The system of claim 21, wherein the plurality of transceiver die complexes are electrically coupled with the SOC along two or more edges of the SOC.

23. A method comprising:
providing a substrate;
placing a transceiver on a side of the substrate; and
placing a waveguide launcher array on the transceiver, wherein at least a portion of the transceiver is between the waveguide launcher array and the side of the substrate.

24. The method of claim 23, wherein the transceiver includes digital circuitry and analog circuitry, and wherein at least a portion of the analog circuitry is between the waveguide launcher array and the side of the substrate.

25. The method of claim 23, further comprising:
placing a die on the side of the substrate; and
electrically coupling the die to the transceiver.
